(19) United States
(12) Patent Application Publication
(10) Pub. No.: US 2007/0288996 A1
(43) Pub. Date: Dec. 13, 2007

(54) INFORMATION PROCESSING DEVICE, NETWORK SYSTEM, NETWORK MANAGEMENT SYSTEM, AND COMPUTER PROGRAM

(75) Inventor: Atsushi Mizuno, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/743,588

(22) Filed: May 2, 2007

(30) Foreign Application Priority Data
May 12, 2006 (JP) 2006-134319
Mar. 27, 2007 (JP) 2007-082390

(51) Int. Cl. H04L 9/32

(52) U.S. Cl. 726/4

(57) ABSTRACT

Disclosed is a network management method which includes a setting step of setting function restriction information for restricting a function of a device that is connected to a network; and a determination step of determining which user can access for each of a plurality of groups in the network, the setting step further including setting the function restriction information about the user determined to be able to access in the determination step.

### BACKGROUND OF THE INVENTION

1. Field of the Invention

The present invention relates to an information processing device, a network system, a network management system, and a computer program, which are particularly suitable to a function management of a device connected to a network.

2. Description of the Related Art

In recent years, computer networks (hereinafter abbreviated as network(s)) in which computers are mutually connected have prevailed. Such networks can be structured in a floor of a building, an entire building, a building group (inside the buildings), a local area, or a further larger area. Then, such networks are mutually connected, thus forming a world class network (that is, the Internet).

Also, a printer, a facsimile machine, and a copying machine (hereinafter referred to as devices), other than computers, are connected to the network in many cases. When the computer sends a job to the device via the network, a user of the computer can utilize the device. For example, with a printing performed when the computer sends a print job to the printer via the network (network printing), there is an advantage that a plurality of computers can share a large-scale high-speed printer or an expensive color printer. Then, with the network printing, there is also an advantage that the printer can perform the printing in response to a print instruction which is issued at a remote place from the printer. Therefore, the network printing has been commonly utilized nowadays.

Moreover, the recent copying machine is provided with not only a function of copying an original, but also a function of executing a print sent from an external client terminal for printing, a function of, with use of a file transfer function of a scanned original or an electronic mail, electronically sending the original or mail to the outside, and the like. Such a copying machine is called an MFP (Multi Function Peripheral).

However, a problem is generated as the MFP has a large number of functions. For example, the scanned information can be sent to the outside, and accordingly a problem occurs in that there is a higher risk of information leak, etc. Also, costs of paper and toner consumed are increased as the number of printing sheets is increased, and there is a demand for restricting the printing functions and the number of printable sheet for each user from a long time ago. It is important to satisfy this demand in view of reducing TOC (Total Cost of Ownership).

In order to solve the above-described problems, a method of managing all users with use of IDs and restricting the function, resource, and period of use time for each ID has been proposed (refer to Japanese Patent Laid-Open No. 11-134136).

Incidentally, according to the above-described conventional technique, information of device use restriction by users is set by a system administrator and managed as data in table format. The information for device use restriction by users is called ACL (Access Control List).

In a case where there is only one ACL in the system, the number of the ACL set by the system administrator and managed as data in table format is one as shown in FIG. 9. In this way, when there is only one ACL in the system, a user has the same restriction even in a case where the user utilizes any device in this system. In an ACL 800 of FIG. 9, for example, “user C” cannot utilize a facsimile (Fax) even in a case where the user utilizes any device in this system.

In view of the above, it is considerable to prepare ACLs for each device so that the restriction contents are varied for each device as shown in FIG. 10. In this way, when a plurality of ACLs 900a to 900n are prepared for each device, the system administrator cannot understand which user can access which device. For this reason, it is necessary for the system administrator to set information of all the users with regard to the plurality of ACLs 900a to 900n prepared for each device for management.

However, in a network where an enormous number of devices and users exists, setting the information of all the users for all the ACLs prepared for each device is an extremely troublesome operation. Therefore, there is a problem of vast costs for managing the system. In the system with a purpose of reducing the TCO, this point is a problem.

### SUMMARY OF THE INVENTION

According to an aspect of the present invention, an information processing apparatus is provided which includes a setting unit configured to set function restriction information for restricting a function of a device that is connected to a network; and a determination unit configured to determine which user can access for each of a plurality of groups in the network, in which the setting unit sets the function restriction information about the user determined to be able to access by the determination unit.

According to another aspect of the present invention, a network management method is provided which includes setting function restriction information for restricting a function of a device that is connected to a network; determining which user can access for each of a plurality of groups in the network; and setting function restriction information about the user determined to be able to access.

Moreover, according to another aspect of the present invention, a computer readable medium is provided containing computer-executable instructions for causing a computer to execute network management tasks. Here, the medium includes computer-executable instructions for setting function restriction information for restricting a function of a device that is connected to a network; computer-executable instructions for determining which user can access for each of a plurality of groups in the network; and computer-executable instructions for setting function restriction information about the user determined to be able to access.

Further features, aspects, and advantages of the present invention will become apparent from the following description of exemplary embodiments with reference to the attached drawings.

### BRIEF DESCRIPTION OF THE DRAWINGS

FIG. 1 shows a logical configuration of a network system according to an exemplary embodiment of the present invention.

FIG. 2 shows a configuration example for realizing respective function elements in the network system shown in FIG. 1 according to an exemplary embodiment of the present invention.

FIG. 3 is a block diagram showing a configuration example of a hardware in a server PC and each of clients according to an exemplary embodiment of the present invention.

FIG. 4 is a block diagram showing a configuration example of a hardware in a multi function copying machine (MFP) according to an exemplary embodiment of the present invention.

FIG. 5 shows a job configuration example according to an exemplary embodiment of the present invention.

FIG. 6 shows an example of a content of an ACT according to an exemplary embodiment of the present invention.

FIG. 7 shows an example of a content of an ACT according to an exemplary embodiment of the present invention.

FIG. 8 is a flowchart for describing an example of a process in which a system administrator utility (AU) sets an ACL according to an exemplary embodiment of the present invention.

FIG. 9 shows a content of only one ACL provided to a system according to an introductory system of an exemplary embodiment of the present invention.

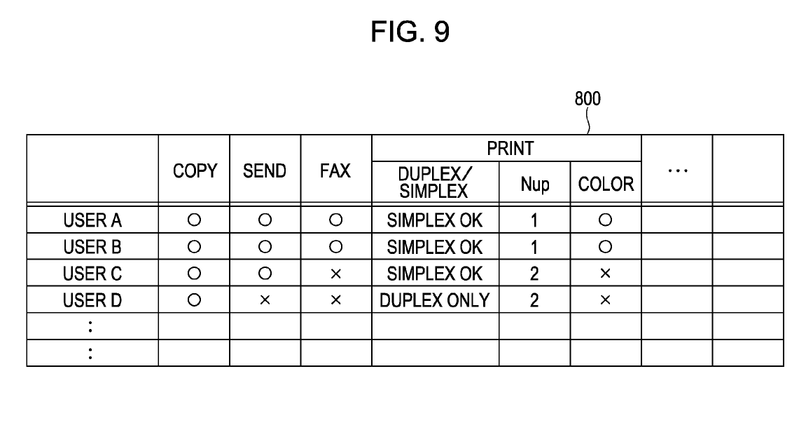

FIG. 10 shows contents of a plurality of ACLs provided to an introductory system of an exemplary embodiment of the present invention.

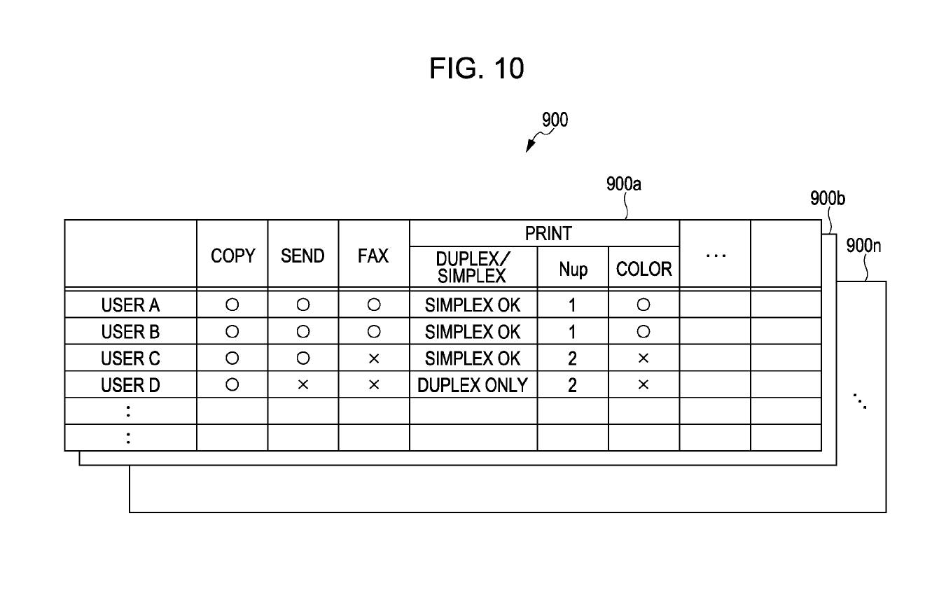

FIG. 11 is a system configuration diagram according to an exemplary embodiment of the present invention.

FIG. 12 shows an example of access control list according to an exemplary embodiment of the present invention.

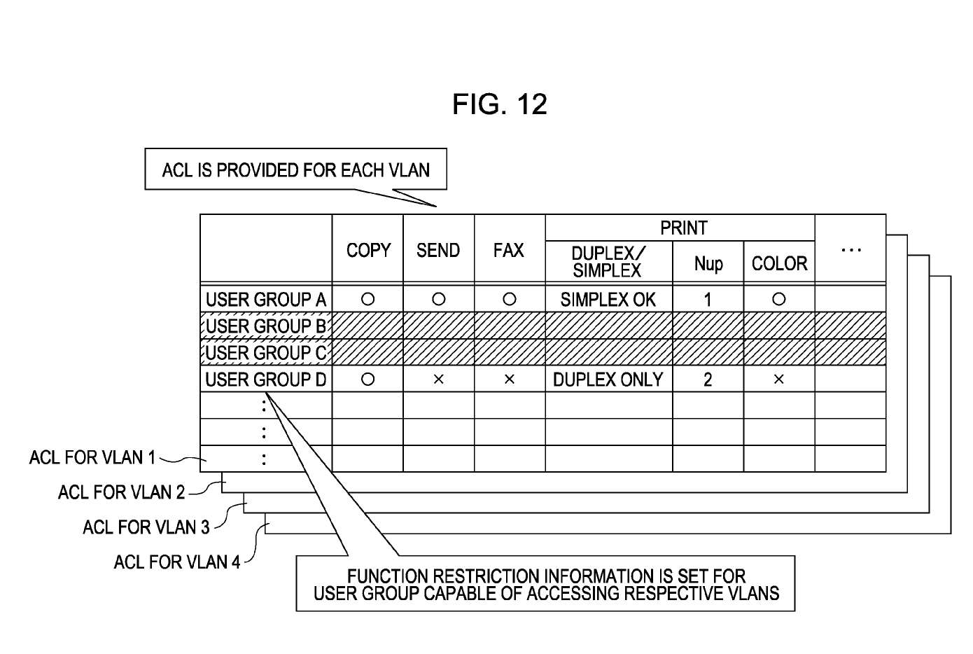

FIG. 13 is a flowchart showing an operation according to an exemplary embodiment of the present invention.

### DESCRIPTION OF THE EMBODIMENTS

### First Exemplary Embodiment

Next, a first exemplary embodiment will be described while referring to the drawings.

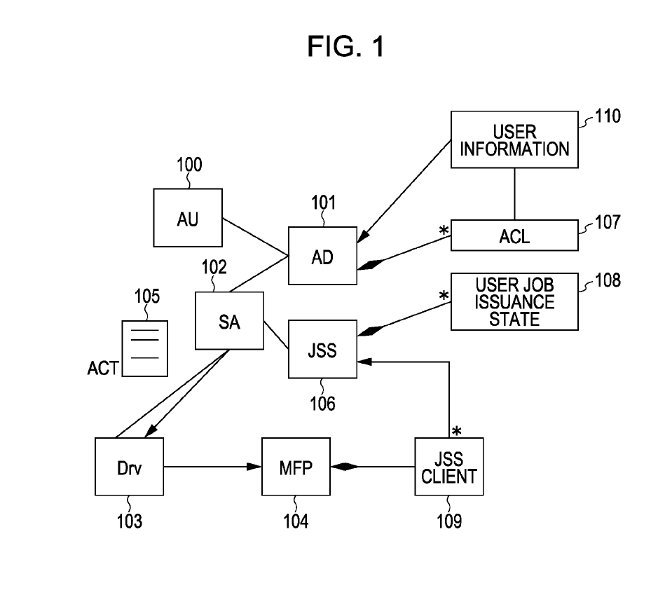

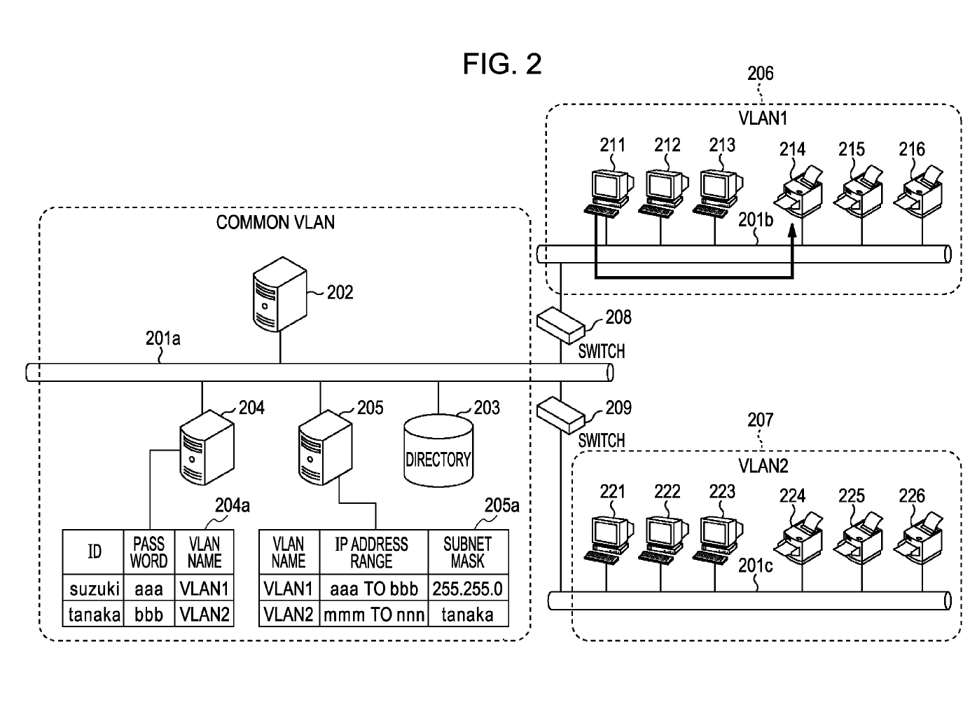

FIG. 1 shows a logical configuration example of a network system according to this exemplary embodiment. It is noted that FIG. 1 is a class diagram described by using a notation of a UML (Universal Modeling Language). FIG. 2 shows a configuration example for realizing respective function elements in the network system shown in FIG. 1.

As shown in FIG. 2, the network system is composed, for example, of devices 214 to 216 and 224 to 226, servers 202, 204, and 205, and client PCs 211 to 213 and 221 to 223, which are mutually connected via a network 201 (including 201a-201c). According to this exemplary embodiment, such an example is described that the network system is a print management system for restricting execution of jobs by users who use the devices 214 to 216 and 224 to 226. Herein, the restriction of the job execution includes access restriction to the devices 214 to 216 and 224 to 226, restriction on the number of printable sheets in the devices 214 to 216 and 224 to 226, and the like. Then, the user is not necessarily an individual, but includes a corporative user such as an organization (for example, a company) and a division in an organization (for example, a company's division).

In FIG. 1, a multi function copying machine (MFP) 104 is equivalent, for example, to the devices 214 to 216 and 224 to 226 shown in FIG. 2. The multi function copying machine (MFP) 104 has a function of copying an original on paper. Then, the multi function copying machine (MFP) 104 has a function of printing print data sent from an external printer driver (Drv) 103. Furthermore, the multi function copying machine (MFP) 104 has a function of reading an original on a sheet of paper and sending image data of the paper original to an external file server or a mail address (i.e., a SEND function).

A system administrator utility (AU) 100 is operated on, for example, the server PC (application server) shown in FIG. 2, and is configured to perform a setting for the network system and to manage the network system. For example, with the system administrator utility (AU) 100, it is possible to perform a setting regarding function restriction information to be held at the user information server (AD) 101.

The user information server (AD) 101 holds user information 110 such as a user ID and a password. Then, in the network system, the user information server (AD) 101 holds function restriction information (ACL) 107 which indicates which function of the multi function copying machine (MFP) 104 can be used for each user. The user information server (AD) 101 is operated on, for example, a directory server 203 shown in FIG. 2. To be more specific, the user information server (AD) 101 is, for example, realized by using an LDAP server, an active directory server, or the like. It should be noted that the detail of the function restriction information (ACL) 107 will be described below.

A ticket issuing server (SA) 102 is operated, for example, on the server PC 202 shown in FIG. 2. The ticket issuing server (SA) 102 is configured to issue a ticket 105 on the basis of the function restriction information 107 stored in the user information server 101 and an actual performance value of job execution by the user stored in an actual performance collection server (JSS) 106. The ticket 105 is called ACT (Access Control Token). The ticket 105 includes information about a function of the multi function copying machine (MFP) 104 that the user can use. To be more specific, a function restriction item for restricting a function of the multi function copying machine (MFP) 104 that executes a job is described as the function restriction information in the ACT 105. Furthermore, information about an upper limit value of a function to be executed by the multi function copying machine (MFP) 104 such as the limit number of sheets to be printed is described as the function restriction information in the ACT 105. The ACT 105 including the above-described information has a role of informing the printer driver (Drv) 103 and the multi function copying machine (MFP) 104, of the access restriction information of users who can use the multi function copying machine (MFP) 104 on the network system.

The printer driver (Drv) 103 is operated, for example, on the client PCs 211 to 213 and 221 to 223 shown in FIG. 2. According to this exemplary embodiment, when the user uses the client PCs 211 to 213 and 221 to 223, login is required in order to clarify which user uses which client PC.

An actual performance collection server (JSS) 106 is configured to count, for example, the actual performance of job execution by the respective users to be notified by an actual performance collection client 109, which will be described below, across a plurality of devices (the MFP 104). Herein, the actual performance of the job execution includes, for example, the actual performance value of the printed sheet number. Then, the actual performance collection server (JSS) 106 holds a user job issuance state 108 that is an execution state of jobs by the respective users in the entire network system. In the example shown in FIG. 1, the printer driver (Drv) 103 obtains the actual performance of the job execution from the multi function copying machine (MFP) 104. Then, the actual performance collection server (JSS) 106 collects the actual performance of the job execution via the actual performance collection client 109.

The user job issuance state 108 is information indicating whether or not after the ACT 105 is issued, the job using the ACT 105 has been completed for the respective users. The user job issuance state 108 is saved in the actual performance collection server (JSS) 106 as data that is managed by the actual performance collection server (JSS) 106.

The actual performance collection client (JSS Client) 109 is provided to each of the multi function copying machines (MFP) 104 and is operated in the multi function copying machine (MFP) 104. The actual performance collection client (JSS Client) 109 informs the actual performance collection server (JSS) 106 of the actual performance of the job execution by the respective users in the multi function copying machine (MFP) 104 to which the actual performance collection client itself belongs. In this way, the actual performance of the job execution by the respective users in the network system is held at the actual performance collection client (JSS Client) 109.

It should be noted that the actual performance of the job execution in the plurality of multi function copying machines (MFP) 104 may be counted by the actual performance collection client (JSS Client) 109.

Next, while referring to FIG. 2, a configuration example for realizing the respective function elements in the network system shown in FIG. 1 will be described in detail.

In FIG. 2, the devices 214 to 216 and 224 to 226, the servers 202, 204, and 205, and the client PCs 211 to 213 and 221 to 223 are connected in the network 201. In the network system according to this exemplary embodiment, for example, a service is provided to a rather local user group such as a user group formed by users on one floor or on a plurality of consecutive floors in one building.

To be more specific, according to this exemplary embodiment, the network 201 is structured by Ethernet (registered trademark) and operated by an authentication VLAN (Virtual LAN). The “authentication VLAN” refers to a virtual LAN (VLAN) which is capable of managing and restricting accesses for each user by using the user ID and the password but which does not manage or restrict accesses for each terminal (for example, PC or MFP). Therefore, when the user logs the network 201 in from any terminal, the user can only access a terminal belonging to a permitted VLAN but cannot access a terminal belonging to an unpermitted VLAN.

The server PC 202 is provided with a computer supporting an OS (Operating System) such as Microsoft Windows (registered trademark) or UNIX (registered trademark) and an application program for realizing the OS and a management function and the like of the OS. The system administrator utility (AU) 100 and the actual performance collection server (JSS) 106 shown in FIG. 1 are operated on the server PC 202.

The directory server 203 holds the function restriction information (ACL) 107, the user information 110, and the like. The user information server (AD) 101 shown in FIG. 1 is operated on the directory server 203.

The authentication VLAN server 204 is configured to manage setting information of the authentication VLAN. According to this exemplary embodiment, the authentication VLAN server 204 includes a management table 204a for managing an ID of a user for logging in the network 201, a password of the user, and a name of the VLAN allocated to the user. The management table 204a may be created by the system administrator or may be automatically created by the authentication VLAN server 204 on the basis of information sent from the client PCs 211 to 213 and 221 to 223.

When the user logs in the network 201, the IP address management server 205 operates in association with the authentication VLAN server 204 to allocate IP addresses to the terminals (the client PCs 211 to 213 and 221 to 223, and the like). According to this exemplary embodiment, the IP address management server 205 includes a management table 205a for managing a name of the VLAN, an IP address range in the VLAN, and a subnet mask of the IP address. The management table 205a may be created by the system administrator or may be automatically created by the IP address management server 205 on the basis of information sent from the client PCs 211 to 213 and 221 to 223. It should be noted that a protocol for managing the IP address includes, for example, DHCP (Dynamic Host Configuration Protocol).

The VLANs 206 and 207 are a logical VLAN composed of the authentication VLAN. It should be noted that herein a name of the VLAN 206 is set as “VLAN 1” and a name of the VLAN 207 is set as “VLAN 2”.

Authentication VLAN switches 208 and 209 are switches for composing the authentication VLAN and are configured to control packets to be sent to the network 201. For example, the authentication VLAN switch 208 controls such that packets sent from VLAN 206 are prevented from being sent to other VLAN like the VLAN 207 or the like. It should be noted that according to this exemplary embodiment, the server PC 202, the directory server 203, the authentication VLAN server 204, and the IP address management server 205 are set to be accessible from any of the VLANs 205 and 206.

The client PCs 211 to 213 and 221 to 223 is provided with a computer supporting an OS such as Microsoft Windows (registered trademark) or UNIX (registered trademark). The printer driver (Drv) 103 shown in FIG. 1 is operated on the client PCs 211 to 213 and 221 to 223.

The devices 214 to 216 and 224 to 226 are equivalent to the multi function copying machine (MFP) 104 shown in FIG. 1. Also, according to this exemplary embodiment, the devices 214 to 216 and 224 to 226 are also provided with the actual performance collection client (JSS Client) 109 shown in FIG. 1.

It should be noted that the above-described configuration is merely an example. For example, all of the actual performance collection client 109, the ticket issuing server (SA) 102, the printer driver (Drv) 103, and the like other than the multi function copying machine (MFP) 104 shown in FIG. 1 may be realized by the client PCs 211 to 213 and 221 to 223. Then, the actual performance collection client 109, the ticket issuing server (SA) 102, the printer driver (Drv) 103, and the like may also be realized by a plurality of server computers.

In other words, an interface between the printer driver (Drv) 103 and the ticket issuing server (SA) 102 may be a physical communication medium or may be composed of a logical interface formed in a software manner for message communication. Herein, the physical communication medium is, for example, a network, a local interface, a CPU bus, etc. Similarly, an interface between the ticket issuing server (SA) 102 and the actual performance collection server (JSS) 106 may be composed of a physical communication medium or a logical interface. Then, an interface between the ticket issuing server (SA) 102 and the user information server (AD) 101 and an interface between the actual performance collection client 109 and the actual performance collection server (JSS) 106 may be composed of a physical communication medium or a logical interface.

In addition, the devices 214 to 216 and 224 to 226 are not limited to the multi function copying machine (MFP). For example, the devices 214 to 216 and 224 to 226 may be a printer, a copying machine, a fax machine, a scanner device, and the like. Furthermore, the above-described functions may be executed while a CPU executes a program or may be realized by way of mounting of a hardware circuit.

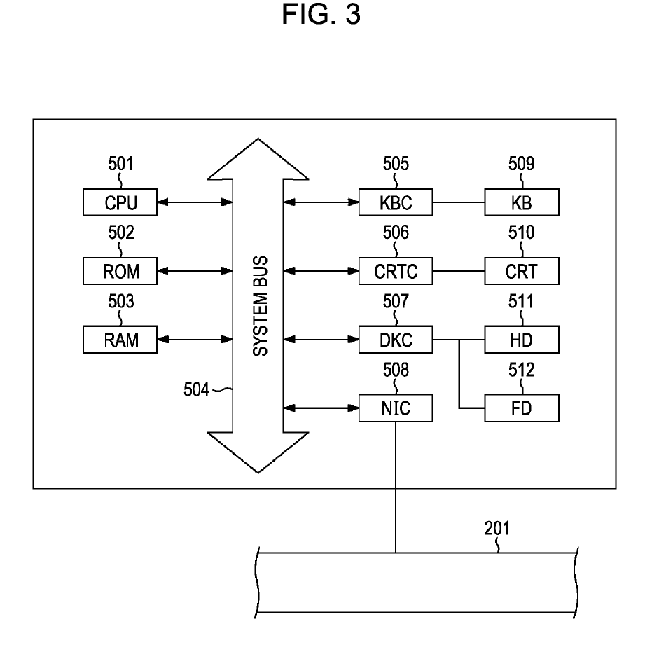

FIG. 3 is a block diagram showing an example of a hardware configuration in the server PC 202 and the respective client PCs 211 to 213 and 221 to 223.

In FIG. 3, a CPU 501 executes a program stored in a ROM 502 with use of the RAM 503, and the like, thus controlling the respective devices 502, 503, and 505 to 508 connected to a system bus 504 in an overall manner. The CPU 501 executes, for example, the functions of the system administrator utility (AU) 100, the ticket issuing server (SA) 102, the printer driver (Drv) 103, the actual performance collection server (JSS) 106, and the actual performance collection client 109. The system administrator utility (AU) 100, the ticket issuing server (SA) 102, the printer driver (Drv) 103, the actual performance collection server (JSS) 106, and the actual performance collection client 109 are stored in the ROM 502 or a hard disc drive (HD) 511. It should be noted that these may be supplied from a flexible disc drive (FD) 512.

The RAM 503 functions as a main memory of the CPU 501, a work area, or the like. A key board controller (KBC) 505 is configured to control instruction inputs from a key board (KB) 509, a pointing device not shown in the drawing, and the like. A CRT controller (CRTC) 506 is configured to control display of a CRT display (CRT) 510.

A disc controller (DKC) 507 is configured to control accesses of the hard disc drive (HD) 511 that stores a boot program, various application programs, an editing file, a user file, etc., and a flexible disc controller (FD) 512. A network interface card (NIC) 508 is configured to exchange data with an external device via the network 201 in bidirectional directions.

It should be noted that as a user interface of the server PC 202, there are a device physically connected to the server PC 202 such as the KB 509 and the CRT 510 as well as a Web interface with use of HTTP/HTML, or the like. Thus, it is possible to operate the server PC 202 via the network 201 from an administrator's computer that is connected to the network 201 and is not shown in the drawing.

In addition, the directory server 203, the authentication VLAN server 204, and the IP address management server 205 can also be realized by using the hardware shown in FIG. 3.

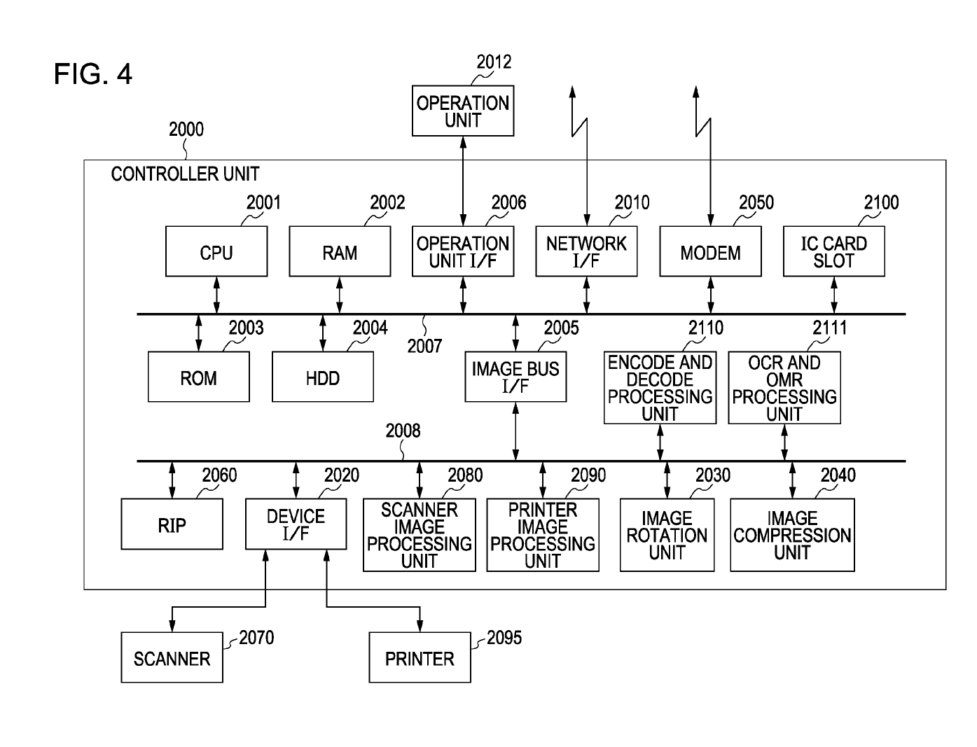

FIG. 4 is a block diagram showing an example of a hardware configuration in the multi function copying machine (MFP) 104.

In FIG. 4, a controller unit 2000 is a controller for achieving a connection to a scanner 2070, the printer 2095, and the network 201 to perform input and output of image information and device information.

A CPU 2001 is a controller for controlling the entirety of the system. A RAM 2002 is a system work memory for operating the CPU 2001 and is also an image memory for temporarily storing image data. A ROM 2003 is a boot ROM, which stores a boot program for the system. An HDD 2004 is a hard disc drive, which stores a system software, image data, history record (log), and the like.

An operation unit I/F 2006 is an interface unit with respect to an operation unit (UI: User Interface) 2012 having a touch panel, and is configured to output image data to be displayed on the operation unit 2012, to the operation unit 2012. Then, the operation unit I/F 2006 also has a function of informing the CPU 2001 of the information input by the user from the operation unit 2012. A network I/F 2010 is connected the network 201 and is configured to input and output the information.

A modem 2050 is connected, for example, to a public circuit and is configured to input and output the information.

An IC card slot 2100 is configured to input an appropriate PIN (Personal Identifier Number) code after an IC card medium is inserted. As a result, it is possible to input and output a key used for encoding and decoding.

An image bus I/F 2005 connects a system bus 2007 to an image bus 2008 for transferring the data at a high speed and function as a bus bridge for converting data structure. The image bus 2008 is composed of a PCI bus or IEEE1394. On the image bus 2008, the following devices are arranged.

A raster image processor (RIP) 2060 is configured to develop a PDL code into a bit map image. A device I/F 2020 connects the scanner 2070 and the printer 2095 which are image input and output device with a control unit 2000 to perform conversion of synchronous system/asynchronous system of the image data. A scanner image processing unit 2080 is configured to perform correction, processing, editing, and the like on the input image data. A printer image processing unit 2090 is configured to perform printer correction, resolution conversion, and the like on print output image. An image rotation unit 2030 is configured to perform rotation of the image data. An image compression unit 2040 is configured to perform a compression and expansion process based on JPEG on multivalued image data and to perform a compression and expansion process based on JBIG, MMR, or MH on binary image data.

An encode and decode processing unit 2110 is a hardware accelerator board for performing an encode and decode processing on the data with use of a key input in an IC card slot 2100. An OCR and OMR processing unit 2111 is configured to perform a process for decoding character information or a two dimensional barcode included in the image data to be converted for the character encode.

Next, an operation outline of the entire network system according to this exemplary embodiment will be described. First, the system administrator utility (AU) 100 sets the function restriction information (ACL) 107 for each user with respect to the user information server (AD) 101. As a result, the function restriction information (ACL) 107 is saved in the user information server (AD) 101.

Next, when a job (such as a print job) is issued to the multi function copying machine (MFP) 104, with use of an ID of a user as an argument, the printer driver (Drv) 103 requests the ticket issuing server (SA) 102 to issue the ACT 105 in which a function that can be used by the user is described. In other words, the printer driver (Drv) 103 sends to the ticket issuing server (SA) 102 an ACT issuance request of the identification information (the user ID) of the user to which the job such as the print job is to be issued.

Next, the ticket issuing server (SA) 102 obtains the function restriction information (ACL) 107 corresponding to the user to which the job is to be issued, among the function restriction information (ACL) 107 stored in the user information server (AD) 101. Furthermore, the ticket issuing server (SA) 102 obtains the actual performance of the job execution by the user to which the job is to be issued from the actual performance collection server (JSS) 106. Herein, the user to which the job is to be issued is identified on the basis of the user identification information included in the ACT issuance request.

Next, the ticket issuing server (SA) 102 determines a setting content of the job that should be permitted to the user on the basis of the function restriction information (ACL) 107 obtained from the user information server (AD) 101 and the actual performance of the job execution obtained from the actual performance collection server (JSS) 106. The ticket issuing server (SA) 102 generates the ACT 105 that reflecting the determined job setting content and provides an electronic signature for proving that the ACT is issued by the ticket issuing server (SA) 102. Then, the ticket issuing server (SA) 102 returns the electronically signed ACT 105 to the Drv 103.

Next, the printer driver (Drv) 103 adds the ACT 105 received from the ticket issuing server (SA) 102 as a part of a header before the job is sent to the multi function copying machine (MFP) 104. Then, the printer driver (Drv) 103 sends the job to which the ACT 105 is added to the multi function copying machine (MFP) 104 to execute the job.

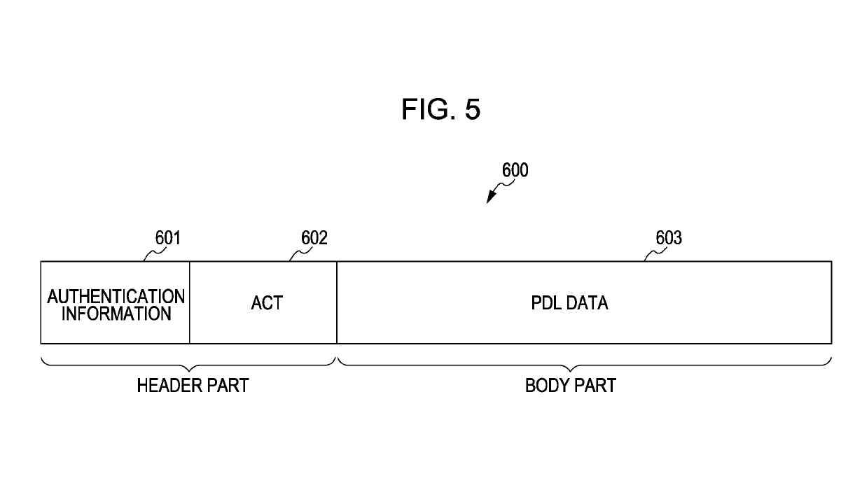

FIG. 5 shows an example of a job configuration.

In FIG. 5, a job 600 is composed of authentication information 601 indicating who is the user issuing the job 600, an access control token (ACT) 602, a body part 603 indicating an operation content that the multi function copying machine (MFP) 104 is requested to perform. In the example shown in FIG. 5, printing of PDL data included in the body part 603 is requested. Herein, the access control token 602 shown in FIG. 5 is equivalent to the ACT 105 received by the printer driver (Drv) 103 from the ticket issuing server (SA) 102 in FIG. 1.

The multi function copying machine (MFP) 104 having received the job 600 of the above-described content compares a list of usable devices described in the access control token 602 of the received job 600 with the request content described in the body part 603. Then, when the request content is included in the usable function, the multi function copying machine (MFP) 104 executes the request content is executed. On the other hand, when the request content is not included in the usable function, the multi function copying machine (MFP) 104 cancels the job 600.

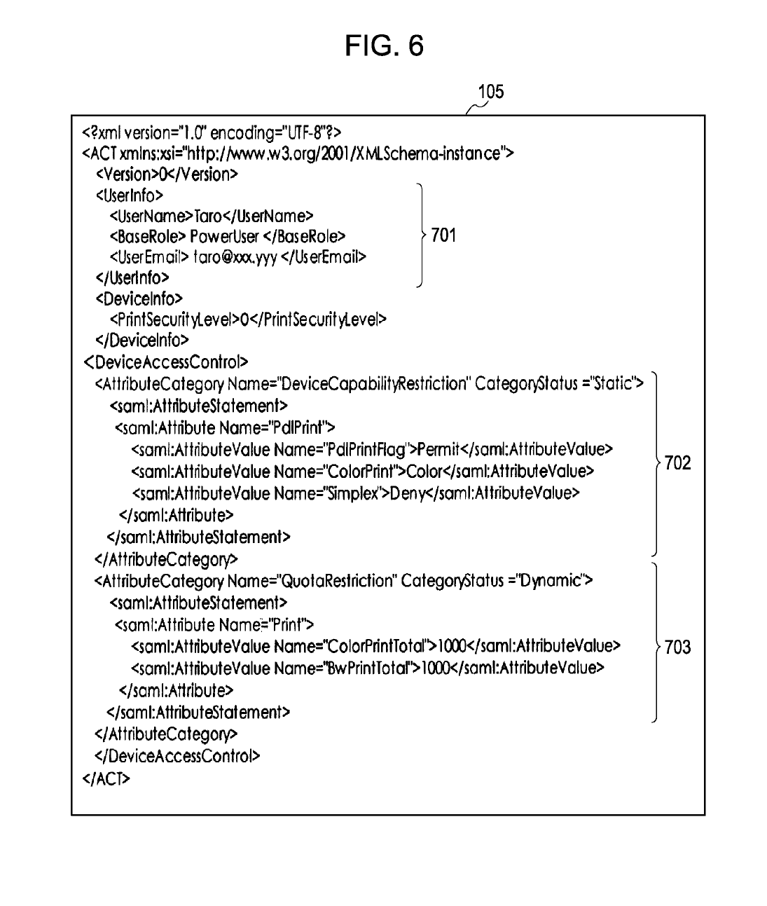

FIG. 6 shows an example of a content of the ACT 105.

In FIG. 6, a description 701 is a part where information related to the user who obtains the access control token 602 is described. In the example shown in FIG. 6, it is described that the user name is Taro, a role “PowerUser” is allocated, and the mail address is “taro@xxx.yyy”.

A description 702 is a part where usable functions by the user who obtains the access control token 602 in the multi function copying machine (MFP) 104 is described. In the example shown in FIG. 6, it is described that a print function called “PDL Print” from the client PC is usable. Then, as information related to a restricted function at the time of printing, it is described that color printing is permitted but simplex printing is not permitted.

A description 703 is a part where an upper limit value of the print sheet number in the multi function copying machine (MFP) 104 that can be used by the user who obtains the access control token 602. In the example shown in FIG. 6, it is described that an upper limit value of the color print sheet number is 1,000 in the entire system and an upper limit value of the black and white print sheet number is 1,000 in the entire system.

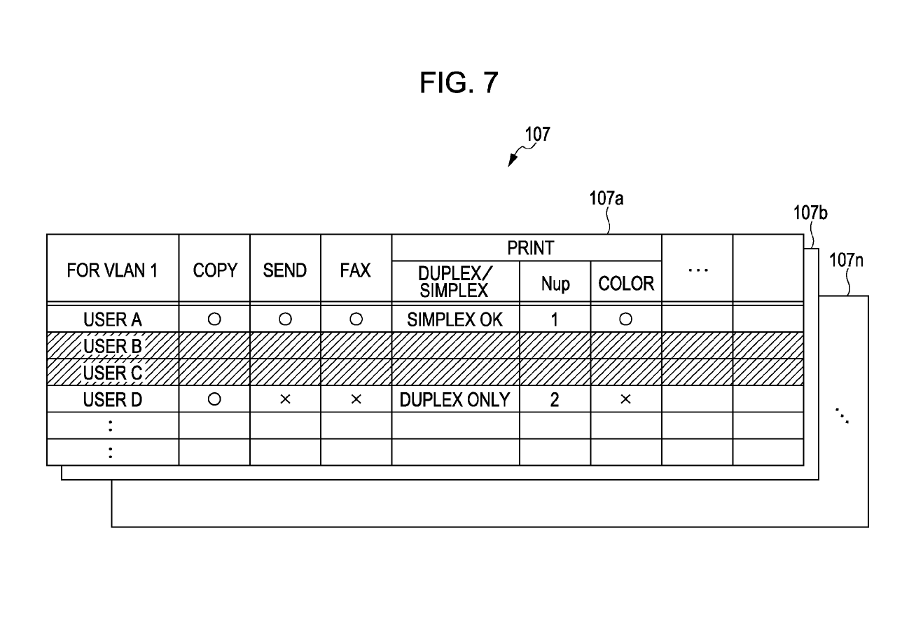

FIG. 7 shows an example of a content of the ACL 107. As shown in FIG. 7, the ACL 107 is composed of a plurality of ACLs 107a, 107b to 107n, etc. The ACL 107 is allocated for each VLAN. In other words, according to this exemplary embodiment, one ACL 107 is applied to one VLAN. In other words, the ACLs 107 exist by the same number as that of the VLANs set with respect to the network 201.

In the ACL 107, for each of users belonging to the VLAN allocated to the ACL 107, the function restriction information related to the restriction of the respective functions that the multi function copying machine (MFP) 104 has.

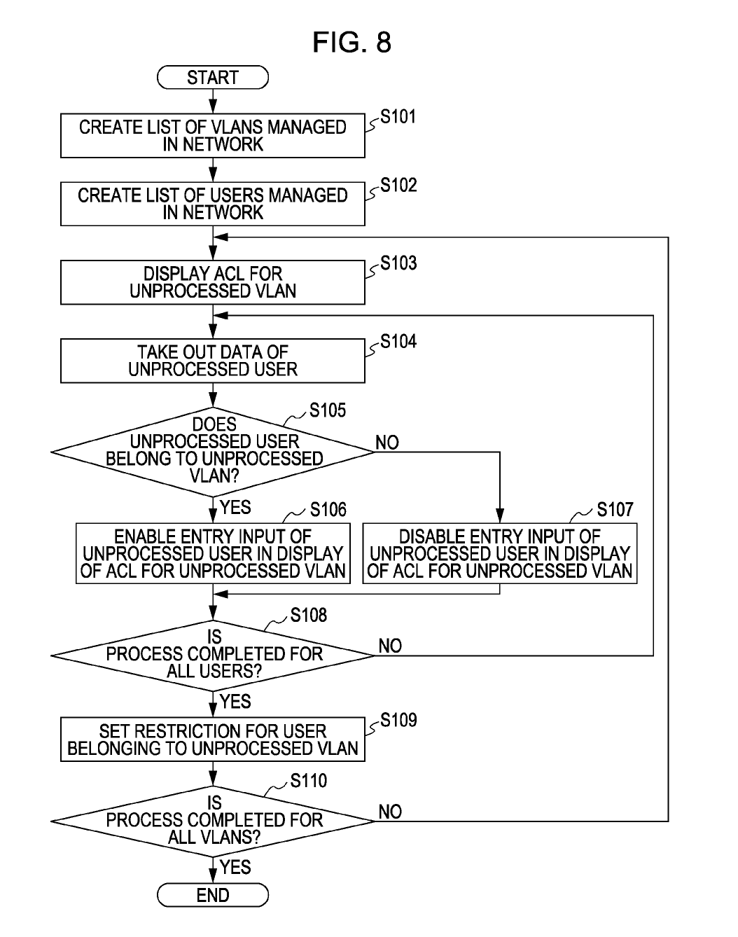

Next, while referring to a flowchart of FIG. 8, a description will be given of a process example for the system administrator utility (AU) 100 to set the ACL 107. It should be noted that herein the system administrator utility (AU) 100 operating on the server PC 202 shown in FIG. 2 sets the ACL 107 held in the user information server (AD) 101 operating on the directory server 203.

First, in Step S101, the system administrator utility (AU) 100 obtains, from the authentication VLAN server 204, VLAN information related to VLAN that is set with respect to the network 201. Then, the system administrator utility (AU) 100 creates a list of VLANs managed in the network 201.

Next, in Step S102, the system administrator utility (AU) 100 obtains, from the user information server (AD) 101 operating on the directory server 203, a list of users managed in the network 201 (the user information 110). Then, the system administrator utility (AU) 100 creates a list of users managed in the network 201.

Next, in Step S103, the system administrator utility (AU) 100 takes out unprocessed VLAN data from the list created in Step S101. Furthermore, the system administrator utility (AU) 100 takes out, from the ACL 107 held in the user information server (AD) 101, the ACL 107 for the unprocessed VLAN. Then, the system administrator utility (AU) 100 displays the ACL 107 for the unprocessed VLAN on the user interface.

Next, in Step S104, the system administrator utility (AU) 100 takes out, from the list of users created in Step S102, unprocessed user data.

Next, in Step S105, the system administrator utility (AU) 100 asks the authentication VLAN server 204 whether or not the unprocessed user taken out in Step S104 belongs to the unprocessed VLAN taken out in Step S103. Then, the system administrator utility (AU) 100 determines whether or not the unprocessed user taken out in Step S104 belongs to the unprocessed VLAN taken out in Step S103 on the basis of this inquiry. As a result of this determination, in a case where the unprocessed user taken out in Step S104 belongs to the unprocessed VLAN taken out in Step S103, a process in Step S106 is executed. On the other hand, in a case where the unprocessed user taken out in Step S104 does not belong to the unprocessed VLAN taken out in Step S103, a process in Step S107 is executed.

In Step S106, the system administrator utility (AU) 100 enables input an entry (row) of the user determined to belong to the unprocessed VLAN in a display area of the ACL 107 for the unprocessed VLAN displayed in Step S103.

On the other hand, in Step S107, the system administrator utility (AU) 100 disables an entry (row) of the user determined to belong to the unprocessed VLAN in the display area of the ACL 107 for the unprocessed VLAN displayed in Step S103.

Next, in Step S108, the system administrator utility (AU) 100 sets the unprocessed user taken out in Step S104 processed in the user list in Step S102. Then, the system administrator utility (AU) 100 determines whether or not all the users in the user list created in Step S102 are set as processed. As a result of this determination, in a case where all the users are set as processed, a process in Step S109 is executed. On the other hand, in a case where not all the users are set as processed, the process in Steps S104 to S108 is repeatedly performed until all the users are set as processed.

Next, in Step S109, the system administrator utility (AU) 100 sets the restriction for the user belonging to the unprocessed VLAN on the basis of the operation of the system administrator with respect to the ACL 107 for the unprocessed VLAN displayed in Step S103. It should be noted that the system administrator uses the user interface provided to the system administrator utility (AU) 100 to perform the operation on the ACL 107 for the unprocessed VLAN. Then, the restriction for the user includes an item of a function restricted to the user, an upper limit value, and the like, as the above-described.

Next, in Step S110, the system administrator utility (AU) 100 sets the unprocessed VLAN taken out in Step S103 as processed in the VLAN list created in Step S101. Then, the system administrator utility (AU) 100 determines whether or not all the VLANs in the VLAN list created in Step S101 are set as processed. As a result of this determination, in a case where all the VLANs are set as processed, this process sequence is ended. On the other hand, in a case where not all the VLANs are set as processed, the process in Step S103 to S110 is repeatedly performed until all the VLANs are set as processed.

As described above, according to this exemplary embodiment, while the operation is performed with use of the authentication VLAN, the network 201 is divided into groups of the plurality of VLANs 206 and 207. Then, in unit of the grouped VLANs 206 and 207, information related to the restriction of functions (the ACL 107) that can be used by the user who can access the VLANs 206 and 207 is set. As a result, regarding the users who can access the VLANs 206 and 207, the setting for the restriction of the functions of the devices 211 to 213 and 221 to 223 (the MFP 104) may be performed.

In addition, the ACL 107 is set in unit of the VLANs 206 and 207, and even when the network 201 is added to the application target of the function restriction, if the application target belongs to the VLANs 206 and 207, it is unnecessary to reset the ACL 107.

From the above-mentioned description, according to this exemplary embodiment, even in the large scale network environment with an enormous number of devices and uses, it is possible to significantly reduce the costs generated when the administrator of the network 201 set the function restriction.

Also, the devices 211 to 213 and 221 to 223 such as the MFP 104 compare the list of usable functions described in the access control token 602 of the job 600 with the request content described in the body part 603. Then, when the request content is included in the usable function, the request content is executed, and when the request content is not included, the job 600 is cancelled. In this way, when the function such as the MFP 104 is used, the function restriction information (the access control token 602) of the user who requests to use the function is obtained, and from the thus function restriction information, the function that can be used by the user is confirmed. Therefore, it is possible to appropriately perform the function restriction.

Moreover, in addition to the restriction on the execution items of functions that the MFP 104 or the like has, the execution upper limit value such as the limit number of sheets to be printed is set, thus making it possible to restrict the function such as the MFP 104 more appropriately.

It should be noted that according to this exemplary embodiment, the case where the network 201 is LAN such as Ethernet (registered trademark) has been described as the example, but the network 201 does not necessarily need to be LAN. For example, when the user is in another building, prefecture, or the like, in order that the remote user participates in the network system of this exemplary embodiment, the network 201 may be composed of WAN, the Internet, or the like. It should be noted that WAN is wide-area Ethernet (registered trademark) or a collective entity composed by connecting some LANs with high speed digital lines such as ISDN telephone lines. These connections can be realized through simple electrical connections with use of a few buses.

Also, according to this exemplary embodiment, the application target of the function restriction is a hardware such as the MFP 104, but the application target of the function restriction does not necessarily need to be a hardware. That is, as long as the function of the device connected to the network 201 is restricted, the application target of the function restriction may be set to a software such as the print driver 103.

In addition, according to this exemplary embodiment, the case where the network 201 is operated under the environment of the authentication VLAN has been described as the example. As described above, in the case where the network 201 is operated under the environment of the authentication VLAN, the management can be performed while the accessible range for the user is managed by the authentication VLAN server 204 and the ACL 107 is allocated for each authentication VLAN. However, the network 201 does not necessarily need to be operated under the environment of the authentication VLAN.

For example, the network 201 may be operated under the environment of a normal VLAN or a subnet group. In this case, the ACL is generated for each normal VLAN or subnet, whereby it is possible to restrict the function similarly to this exemplary embodiment. It should be noted that in the normal VLAN or the subnet, it is necessary to set the accessible range for the network 201, not for each user but for each client PC. Thus, it is necessary to set a correspondence table to understand which user uses which client PC.

It should be noted that in the above description, the subnet is a logical network, and for example, in the specification of IP v4, it is possible to specify which subnet each of the network addresses belong with use of a subnet mask. In this way, in a case where the network 201 is caused to operate under the environment of the subnet group, for example, the accessible range for the user may be managed by the IP address management server 205.

Also, according to this exemplary embodiment, the devices 211 to 213 and 221 to 223 (the MFP 104) determines whether or not the job 600 can be performed but the configuration is not necessarily limited to the above. For example, when the printer driver (Drv) 103 generates a job, it may be determined whether or not the job can be executed by the device.

In addition, according to this exemplary embodiment, the printer driver (Drv) 103 obtains the ACT 105 from the ticket issuing server (SA) 102 and include the access control token (ACT) 602 having the thus obtained ACT 105, in the job 600. However, the configuration is not necessarily limited to the above. For example, the devices 211 to 213 and 221 to 223 (the MFP 104) may obtain information equivalent to the access control token (ACT) 602.

To be more specific, for example, the printer driver (Drv) 103 issues a job including the authentication information 601 and the body part 603 (a job not including the access control token 602) to the devices 211 to 213 and 221 to 223 (the MFP 104). The devices 211 to 213 and 221 to 223 (the MFP 104) obtains the ACT 105 from the ticket issuing server (SA) 102 and also obtains the job from the printer driver (Drv) 103. Then, the devices 211 to 213 and 221 to 223 (the MFP 104) compares the list of usable functions described in the ACT 105 with the request content described in the body part 603 to determine whether or not the thus obtained job is to be executed on the basis of the comparison result.

Also, as in this exemplary embodiment, when the ACL 107 is generated for each VLAN, the management of the ACL 107 is facilitated and thus preferable, but the configuration is not necessarily limited to the above. For example, in the table shown in FIG. 7, the management is performed while each user adds an item indicating which VLAN the user belongs to, whereby it becomes unnecessary to generate the ACL 107 for each VLAN.

When the above-described exemplary embodiment is operated, it is necessary to set the function restriction each time when a user of AD is added. However, according to an exemplary embodiment described below, it is possible to set the function restriction for a user group of AD. For this reason, even when a user is added, the restriction is applied for the belonging user group, and thus the setting is unnecessary.

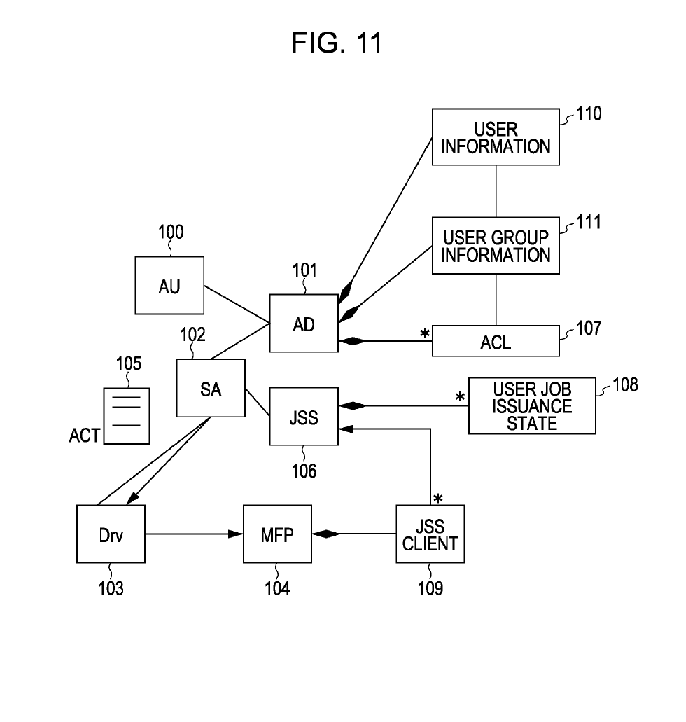

FIG. 11 is a class diagram showing a logical configuration of an entire system according to an exemplary embodiment of the present invention. A different point from FIG. 1 will be particularly described.

It should be noted that the system according to this exemplary embodiment is composed of a device, a server, and a client PC which are connected on a network. Then, this system is a print management system for performing an access restriction for a user or a user group which uses the device and a job execution restriction for the number of printable sheets. It should be noted that herein the user group refers to a group including at least one user ID.

Denoted by reference numeral 100 is a system administrator utility (hereinafter referred to as AU). The AU 100 is configured to be operated on a server PC that is not shown in the drawing and to perform setting and management of the system. In particular, it is possible to set the function restriction information of the user information server 101.

Reference numeral 101 denotes a user information server (hereinafter referred to as AD). The user information server saves user information 110 such as the user ID and the password, user group information 111 indicating which user belongs to which user group, and further, function restriction information (hereinafter referred to as ACL) 107 indicating which function is allowed to be used by each user group in the system. The user information server 101 is realized, for example, with use of an LDAP server, an active directory server, or the like. It should be noted that the ACL 107 will be described in detail later.

Denoted by reference numeral 102 is a ticket issuing server (hereinafter referred to as SA). On the basis of the function restriction information of the respective user groups stored in the AD 101 and the job execution actual performance of the user group accumulated in the actual performance collection server 106, the ticket issuing server issues a ticket in which information about a usable function is described. This ticket is called access control token (hereinafter referred to as ACT). The ACT is data having a role of transmitting access restriction information for a user on the system from a server to a device. In the ACT, information related to upper limit values such as a function restriction item for job execution with respect to the user and a limit number of sheets to be printed is described.

Reference numeral 103 denotes a printer driver (hereinafter referred to as Drv). The Drv 103 is configured to be operated on a client PC not shown in the drawing. When the client PC is used, login is necessary in order to find out which user uses this client PC.

Denoted by reference numeral 104 is a multi function copying machine (hereinafter referred to as MFP). The MFP 104 has not only a function of copying an original on paper, but also a function of printing print data sent from an external driver and further a function of reading an original on paper to send the image data to an external file server or a mail address (SEND function).

Reference numeral 105 denotes an access control token (hereinafter referred to as ACT). The ACT 105 is an ACT in which information about the executable function by the user in the MFP 104 or the printable upper limit sheet number is described.

Denoted by reference numeral 106 is an actual performance collection server (JSS). The JSS is configured to count the actual performance of the job execution printed sheet number for each user group, which is notified from an actual performance collection client 109 described below, across a plurality of print device printers (according to this exemplary embodiment, the MFP 104). Then, the JSS holds a user job issuance state 108 that is the print actual performance for each user group in the entire system. In this case, the job execution actual performance that the Drv 103 obtains from the MFP 104 is collected by the JSS 106 via the actual performance collection client 109.

Reference numeral 108 denotes a user job issuance state. This is information as to whether or not after the ACT 105 is issued a print job with use of the ACT is completed for each user. The user job issuance state 108 is counted for each user ID or each user group to which the user ID belongs. The user job issuance state 108 is saved in the JSS 106 as the data managed by the JSS 106.

Denoted by reference numeral 109 is an actual performance collection client (hereinafter referred to as JSS Client). The JSS Client 109 is operated on the MFP for each MFP. Then, the JSS Client 109 notifies the JSS 106 of the actual performance of the print sheet number of each user on the MFP. Alternatively, the job execution actual performance may be counted by the JSS Client 109 across a plurality of devices (for example, printers). Examples of the job execution actual performance include the actual performance of the print sheet number. As a result, the job execution actual performance of each of the users and the user group in the management system is held at the JSS Client 109.

A specific sequence is as follows:
1. The AU 100 sets the function restriction information for each user group with respect to the AD 101 and the ACL 107 is saved in the AD 101.
2. The Drv 103 sends, to the SA 102, the ACT issuance request added with identification of the user to which the job is issued.
3. The SA 102 specifies the user group to which this user belongs and obtains among the ACLs 107 stored in the AD 101, the function restriction information corresponding to the user group to which the user belongs to which the job is issued. The SA 102 further obtains the job execution actual performance corresponding to the user group to which the user belongs who has an ACT send request from the JSS 106. The SA 102 determines the job setting content for permitting the user on the basis of the thus obtained function restriction information and the job execution actual performance. The SA 102 generates the ACT 105 which reflects the setting content of this job. Then, the SA 102 provides an electronic signature for proving that the SA 102 has issued this ACT and sends the ACT to the Drv 103.
4. The Drv 103 sends the job and the ACT 105 to the MFP 104 for execution.

Next, an example operation outline of the system shown in FIG. 11 will be described.

The AU 100 sets the function restriction information for each user group with respect to the AD 101, in other words, the AU 100 sets the ACL 107. When the Drv 103 issues the print job to the MFP 104, issuance of the ACT 105 describing the usable function for this user is requested to the SA 102 with use of the user ID as an argument. The SA 102 specifies the user group to which this user belongs. On the basis of the ACL 107 stored in the AD 101, the SA 102 issues the ACT 105 describing the usable function and returns the ACT to the Drv 103. In order to send the job to the MFP 104, the Drv 103 adds the ACT 105 having been received previously to the job as a part of the header for the sending. Herein, the access control token 602 of FIG. 11 is equivalent to the ACT 105 received from the SA 102 by the Drv 103 in FIG. 11.

The MFP 104 having received the job compares the list of the usable functions described in the access control token 602 with the request content described in the body part 603. When the request content is included in the usable functions, the request is executed. If the request content is not included in the usable functions, the job is cancelled.

Moreover, FIG. 11 shows a content example of the ACL 107.

The ACL 107 is composed of a plurality of ACLs. The ACL is allocated in unit of VLAN. In other words, one ACL is applied to one VLAN.

In this one ACL, it is possible that regarding the user group capable of accessing the VLAN, the function restriction information about each function of the MFP is set in unit of user group and managed.

Next, a process in which the AU 100 sets the ACL 107 will be described.

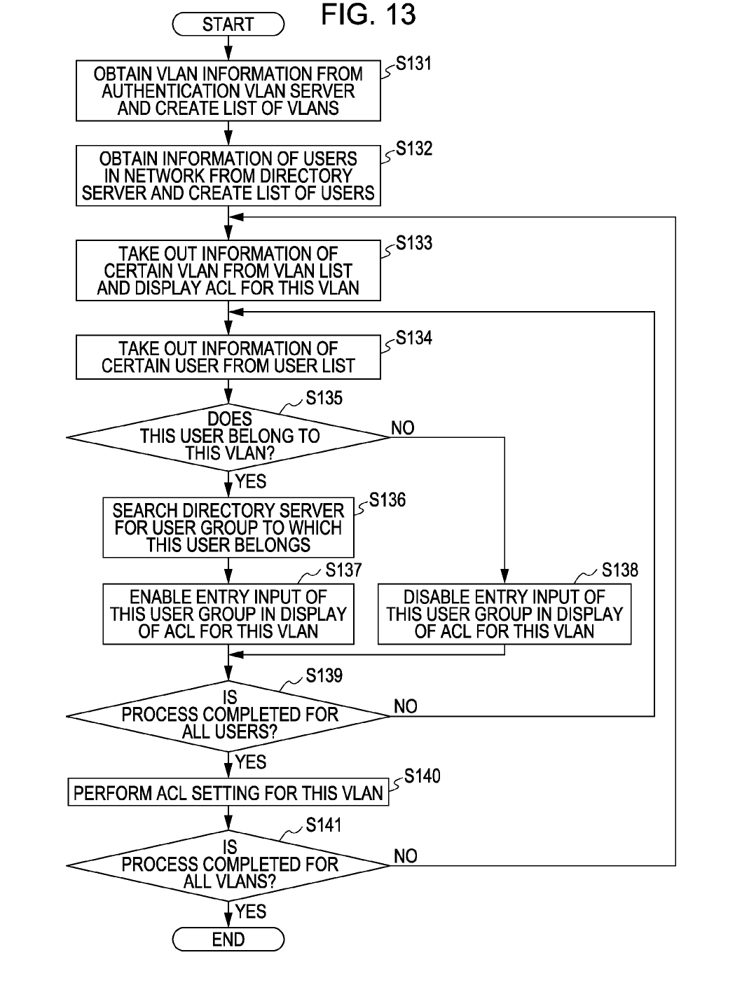

In the description, in FIG. 11, the AU 100 on the server PC 202 sets the ACL 107 held in the AD 101 on the directory server 203. While referring to a flowchart of FIG. 13, example flows of the above-described process will be described in detail.

The subject from now on is basically the AU 100. In Step S131, the AU 100 obtains VLAN information from the authentication VLAN server 204 and creates the VLAN list to be managed in the network 1.

In Step S132, the AU 100 obtains a list of users to be managed by the network 1 from the directory server 203 to create a user list.

In Step S133, the AU 100 takes out data of the unprocessed VLAN from the VLAN list and further, takes out ACL for this VLAN from the ACL 107 to be displayed on the user interface. In Step S134, from the user list, the AU 100 takes out data of the unprocessed user.

In Step S135, the AU 100 asks the authentication VLAN server 204 as to whether this user belongs to this VLAN. When this user belongs to this VLAN, a process in Step S136 is executed, and when this user does not belong to this VLAN, a process in Step S138 is executed. In Step S136, the AU 100 searches the directory server 203 for the user group to which this user belongs.

In Step S137, in the ACL display of this VLAN, the AU 100 enables the entry of this user (row). In Step S138, in the ACL display of this VLAN, the AU 100 sets the entry of this user (row) as gray out and disables the entry.

In Step S139, the AU 100 sets this user as processed and determines whether or not the all the users in the user list are set as processed. When all the users are set as processed, a process in Step S140 is executed, and when all the users are not set as processed, the flow returns to Step S134. In Step S140, the user of the AU 100 (the system administrator) sets ACL setting for this VLAN. In Step S141, the AU 100 sets this VLAN as processed and determines whether or not the all VLANs in the VLAN list are set as processed. When all VLANs are set as processed, this process sequence is ended and when all VLANs are not set as processed, the flow returns to Step S133.

### Other Exemplary Embodiments

In order to operate various devices for realizing the functions of the above-described exemplary embodiments, a program code of a software for realizing the functions of the above-described exemplary embodiments may be supplied to a computer in a device or a system connected to the various devices. The example of embodying the functions by operating the various devices on the basis of the programs stored in the computer (CPU or MPU) in the device or the system is in the scope of the present invention.

Also, in this case, a program code itself of the software realizes the functions of the above-described exemplary embodiments. Then, the program code itself, a unit configured to supply the program code to the computer, for example, a recording medium storing the program code constitutes the present invention. As the recording medium for storing the program code, for example, a flexible disc, a hard disc, an optical disc, an optomagnetic disc, a CD-ROM, a magnetic tape, a non-volatile memory card, a ROM, or the like can be used.

In addition, the functions of the above-described exemplary embodiments are realized not only when the computer executes the supplied program code but also when the program code works together with an operating system running on the computer, other application software, or the like. It is needless to mention that the program code is included in an exemplary embodiment of the present invention.

Moreover, after the supplied program code is stored in a memory provided to a function expansion board of the computer, a CPU or the like provided to function expansion board executes a part or an entirety of the actual process on the basis of instructions of the program code. It is needless to mention that the case where the functions of the above-described exemplary embodiments are realized through the process is also in the scope of the present invention.

Furthermore, after the supplied program code is stored in a memory provided to a function expansion unit of the computer, a CPU or the like provided to function expansion unit executes a part or an entirety of the actual process on the basis of instructions of the program code. It is needless to mention that the case where the functions of the above-described exemplary embodiments are realized through the process is also in the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Applications No. 2006-134319 filed May 12, 2006 and No. 2007-082390 filed Mar. 27, 2007, which are hereby incorporated by reference herein in their entirety.

What is claimed is:

1. An information processing apparatus, comprising:
a setting unit configured to set function restriction information for restricting a function of a device that is connected to a network; and
a determination unit configured to determine which user can access for each of a plurality of groups in the network,
wherein the setting unit sets the function restriction information about the user determined to be able to access by the determination unit.

2. The information processing apparatus according to claim 1, further comprising a creation unit configured to create a list of users who can access for each of the plurality of groups, wherein the determination unit determines which user can access for each of the plurality of groups with use of the list created by the creation unit.

3. The information processing apparatus according to claim 1, further comprising:
an obtaining unit configured to obtain information related to a user who is an issuance source of the job to the device that is connected to the network;
a confirmation unit configured to confirm a content of a function that can be executed by a device which is an issuance destination of the job, with use of the function restriction information related to the user specified on the basis of the information obtained by obtaining unit; and
an execution unit configured to execute the job in accordance with the content confirmed by the confirmation unit.

4. The information processing apparatus according to claim 1, further comprising a registration unit configured to register a plurality of groups in the network, wherein the determination unit determines which user can access for each of the plurality of groups registered by the registration unit.

5. The information processing apparatus according to claim 1, wherein the function restriction information includes at least one of information as to whether or not the function of the device connected to the network is executed and information indicating how much the function of the device connected to the network is executed.

6. The information processing apparatus according to claim 1, wherein the setting unit sets the function restriction information, for each of the plurality of groups in the network, indicating which user can access for the group.

7. The information processing apparatus according to claim 1, wherein the plurality of groups in the network is a group composed of an authentication VLAN.

8. A network management method, comprising:
setting function restriction information for restricting a function of a device that is connected to a network;
determining which user can access for each of a plurality of groups in the network; and
setting function restriction information about the user determined to be able to access.

9. The network management method according to claim 8, further comprising:
creating a list of users who can access for each of the plurality of groups; and
determining which user can access for each of the plurality of groups with use of the created list.

10. The network management method according to claim 8, further comprising:
obtaining information related to a user who is an issuance source of the job to the device that is connected to the network;
confirming a content of a function that can be executed by a device which is an issuance destination of the job, with use of the function restriction information related to the user specified on the basis of the obtained information; and
executing the job in accordance with the confirmed content.

11. The network management method according to claim 8, further comprising:
registering a plurality of groups in the network; and
determining which user can access for each of the plurality of the registered groups.

12. The network management method according to claim 8, wherein the function restriction information includes at least one of information as to whether or not the function of the device connected to the network is executed and information indicating how much the function of the device connected to the network is executed.

13. The network management method according to claim 8, further including setting the function restriction information, for each of the plurality of groups in the network, indicating which user can access for the group.

14. The network management method according to claim 8, wherein the plurality of groups in the network is a group composed of an authentication VLAN.

15. A computer readable medium containing computer-executable instructions for causing a computer to execute network management tasks, the medium comprising:
computer-executable instructions for setting function restriction information for restricting a function of a device that is connected to a network;
computer-executable instructions for determining which user can access for each of a plurality of groups in the network; and
computer-executable instructions for setting function restriction information about the user determined to be able to access.

16. The computer readable medium according to claim 15, further comprising:
computer-executable instructions for creating a list of users who can access for each of the plurality of groups; and
computer-executable instructions for determining which user can access for each of the plurality of groups with use of the created list.

17. The computer readable medium according to claim 15, further comprising:
computer-executable instructions for obtaining information related to a user who is an issuance source of the job to the device that is connected to the network;
computer-executable instructions for confirming a content of a function that can be executed by a device which is an issuance destination of the job, with use of the function restriction information related to the user specified on the basis of the obtained information; and
computer-executable instructions for executing the job in accordance with the confirmed content.

18. The computer readable medium according to claim 15, further comprising:
computer-executable instructions for registering a plurality of groups in the network; and
computer-executable instructions for determining which user can access for each of the plurality of the registered groups.

19. The computer readable medium according to claim 15, wherein the function restriction information includes at least one of information as to whether or not the function of the device connected to the network is executed and information indicating how much the function of the device connected to the network is executed.

20. The computer readable medium according to claim 15, further including setting the function restriction information, for each of the plurality of groups in the network, indicating which user can access for the group.

21. The computer readable medium according to claim 15, wherein the plurality of groups in the network is a group composed of an authentication VLAN.

22. A computer program stored on a readable medium containing computer-executable instructions for causing a computer to execute network management tasks, the program comprising:
computer-executable instructions for setting function restriction information for restricting a function of a device that is connected to a network;
computer-executable instructions for determining which user can access for each of a plurality of groups in the network; and
computer-executable instructions for setting function restriction information about the user determined to be able to access.
